(19) United States
(12) Patent Application Publication
(10) Pub. No.: US 2014/0334296 A1
(43) Pub. Date: Nov. 13, 2014

(54) Aggressive Transmission Control Protocol (TCP) Retransmission

(71) Applicant: FUTUREWEI TECHNOLOGIES, INC., Plano, TX (US)

(72) Inventors: John Waclawsky, Bartlett, IL (US); Yufeng Xia, Shenzhen (CN); Zechao Meng, Shenzhen (CN)

(73) Assignee: FutureWei Technologies, Inc., Plano, TX (US)

(21) Appl. No.: 13/893,000

(22) Filed: May 13, 2013

(51) Int. Cl. H04L 12/801

(52) U.S. Cl. CPC H04L 47/12
USPC 370/230

(57) ABSTRACT

Selectively ignoring congestion conditions may allow for more efficient transmission control protocol (TCP) communication in instance where reducing the transmission rate for a flow will not meaningfully mitigate congestion in the network or is otherwise undesirable. By way of example, congestion conditions may be ignored when a specific type of traffic flow is being communicated (e.g., short flows, high priority flows, etc.), when a traffic flow is being communicated at a low transmission rate, when a traffic flow is destined for certain type of network (e.g., a wireless network, etc.), or during any other situation in which reducing the transmission rate is undesirable. In some networks, a transmission rate is maintained until a certain number of duplicate ACKs are received (e.g., three duplicate ACKs, etc.) in order to ensure that congestion is indeed present before reducing quality of service (QoS).

### TECHNICAL FIELD

The present invention relates generally to communications, and in specific embodiments, to communicating Aggressive Transmission Control Protocol (TCP) Retransmission.

### BACKGROUND

Transmission Control Protocol (TCP) is a core protocol corresponding to the transport layer of the Internet Protocol (IP) suite, and serves as an intermediate level/layer between the application layer (e.g., the program) and the internet protocol (IP) layer. TCP provides reliable and ordered delivery of a data from a program on one computer to another program on another computer, and is used for most major Internet applications (e.g., browsing, email, file transfer, etc.).

### SUMMARY OF THE INVENTION

Technical advantages are generally achieved, by embodiments of this disclosure which describe transmission control protocol (TCP) connection control parameter in-band signaling.

In accordance with an embodiment, a method for TCP communication is provided. In this example, the method includes beginning to transmit a traffic flow over a TCP connection, detecting a congestion condition, and determining whether to recognize or ignore the congestion condition. The method further includes continuing to transmit the traffic flow over the TCP connection without reducing a transmission rate upon determining to ignore the congestion condition. An apparatus for performing this method is also provided.

In accordance with another embodiment, another method for TCP communication is provided. In this example, the method includes beginning to transmit a traffic flow over a TCP connection, detecting a congestion condition, and determining whether a transmission rate over the TCP connection exceeds a threshold. The method further includes ignoring the congestion condition when the transmission rate fails to exceed the threshold. An apparatus for performing this method is also provided.

In accordance with another embodiment, yet another method for TCP communication is provided. In this example, the method includes storing a traffic flow in a queue, beginning to transmit the traffic flow over a TCP connection in accordance with a congestion algorithm, detecting a congestion condition, and determining whether an amount of data remaining in the queue exceeds a threshold. The method further includes ignoring the congestion condition when the amount of data remaining in the queue fails to exceed the threshold. An apparatus for performing this method is also provided.

In accordance with another embodiment, yet another method for TCP communication is provided. In this example, the method includes beginning to transmit a traffic flow over a TCP connection, detecting a congestion condition, receiving a duplicate ACK message indicating that one or more packets in the traffic flow were not successfully received by a receiving device, and determining whether a number of duplicate ACK messages received exceeds a threshold The method further includes re-transmitting the one or more packets without reducing a transmission rate of the TCP connection when the number of duplicate ACK messages fails to exceed the threshold. An apparatus for performing this method is also provided.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a diagram of a network architecture of TCP connections;

FIG. 2 illustrates a diagram of a typical TCP transmission activity sequence;

FIG. 3 illustrates a diagram of an embodiment of a network architecture of TCP connections;

FIG. 4 illustrates a diagram of another embodiment of a network architecture of TCP connections;

FIG. 5 illustrates a diagram of an embodiment middlebox;

FIG. 6 illustrates a flowchart of an embodiment method for communicating a traffic flow over a TCP connection;

FIG. 7 illustrates a block diagram of an embodiment communications device.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims. Aspects of this disclosure may be applied to various communication protocols. Notably, while much of this disclosure is discussed in the context of transmission control protocol (TCP), embodiments discussed herein may be applied to any communication protocol. Indeed, aspects of this disclosure may be particularly useful for protocols in which control/manipulation of communication parameters influences network performance. Techniques for dynamically optimizing TCP connections are disclosed in U.S. Non-Provisional application Ser. No. 13/802,329 filed on Mar. 13, 2013, entitled “Dynamic Optimization of TCP Connections,” which is incorporated herein by reference as if reproduced in its entirety.

To reduce network congestion, conventional TCP algorithms typically lower the transmission rate or window size for a TCP connection upon detecting a congestion condition. However, in some situations it is undesirable or otherwise unnecessary to reduce the transmission rate or window size. For example, some traffic flows (e.g., short flows, low rate flows, etc.) have little impact on network congestion such that reducing their transmission rate may diminish quality of service (QoS) for those flows without meaningfully mitigating congestion. By way of another example, some flows may have only a small amount of data remaining in their queue such that it is more beneficial to complete transmission of the flow without reducing the window size or transmission rate. As yet another example, it may be desirable to reduce the transmission of traffic flows based on a priority level such that transmission rates of lower priority flows are reduced before that of higher priority flows.

Aspects of this disclosure provide a mechanism for selectively ignoring congestion conditions such that the transmission rate for some flows is not maintained following detection of the condition. For example, congestion conditions may be ignored for short flows, high priority flows, flows being communicated at low transmission rates, flows destined for wireless networks, or any other situation in which reducing the transmission rate is undesirable. The mechanism for detecting congestion conditions may vary. In some networks, destination endpoints may send a series of duplicate acknowledgment (ACK) messages to indicate that a packet was not received. In such networks, embodiments of this disclosure may maintain the transmission rate until a certain number of duplicate ACKs are received (e.g., three duplicate ACKs, etc.) in order to ensure the presence of congestion before reducing QoS.

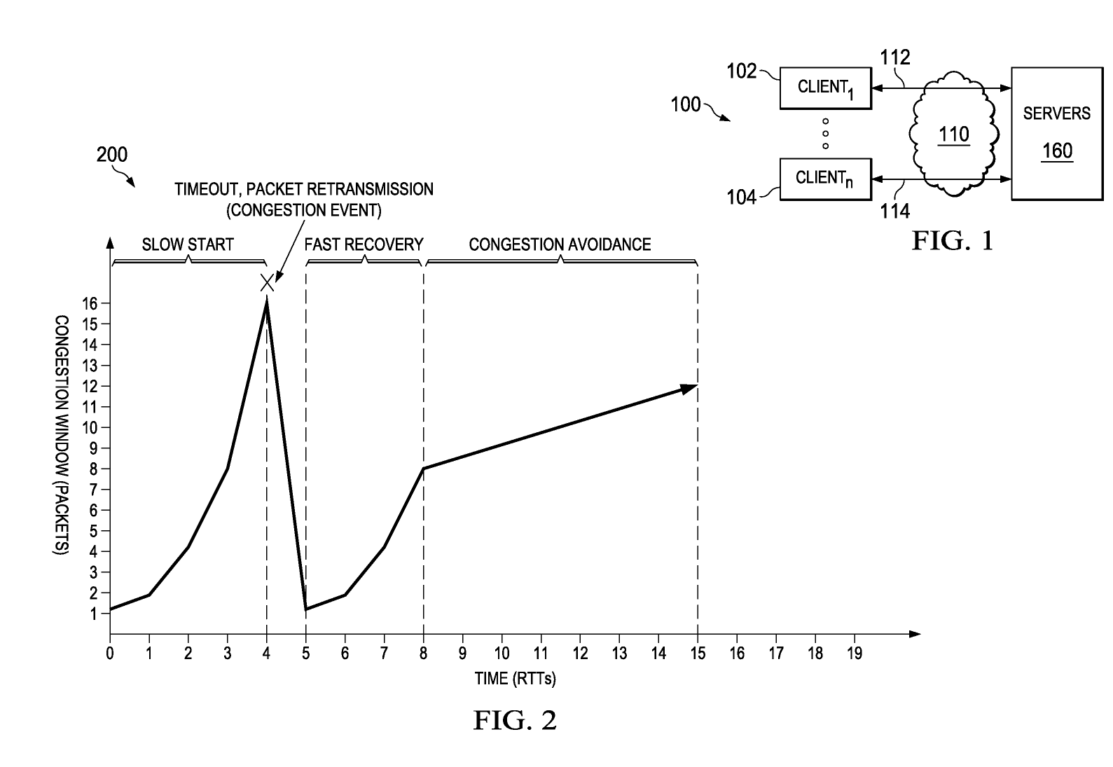

FIG. 1 illustrates a network architecture 100 comprising a plurality of clients 102-104, a network 110, and one or more servers 160. As shown, the client 102 sends/receives data over network 110 via a TCP connection 112, while the client 104 sends/receives data over the network 110 via a TCP connection 114. The TCP connections 112-114 may be constructed and de-constructed each time a TCP session is initiated between the clients 102-104 and one or more servers 160. Alternatively, the TCP connections 112-114 may be persistent TCP connections.

TCP algorithms may operate by increasing/decreasing their transmission rate (e.g., window size) to manage or avoid congestion. FIG. 2 illustrates a TCP transmission sequence 200, as may occur between a client and a server. Notably, transmission rates may be expressed in packets per round trip time (RTT), which is the length of time it takes for an acknowledgment to be received following the transmission of a packet. Further, the TCP transmission sequence 200 is included herein merely as an example of how some TCP parameters affect connection performance, and does not serve to limit this disclosure. Many TCP protocols initialize with a slow start phase, which may include transmitting packets at a low rate (e.g., one-packet/RTT) and thereafter incrementing the rate (exponentially or otherwise) until a congestion event occurs (or until the transmission is completed). The congestion event may include the failure to receive an ACK message for a transmitted packet (e.g., after a timeout), the reception of a negative acknowledgment (NACK) message, or any other event suggesting that a packet transmission was unsuccessful. The TCP transmission sequence 200 may respond to the congestion event by decrementing the transmission rate to a bottom or floor (e.g., one-packet/RTT) in an attempt to alleviate the perceived congestion. After reaching the bottom or floor, the TCP transmissions sequence 200 may proceed in accordance with a FAST recovery phase, which includes increasing the packet transmission rate (e.g., exponentially or otherwise) for a period of time or until the packet transmission rate reaches a threshold. After the FAST recovery period, the TCP transmissions sequence 200 may proceed in accordance with a congestion avoidance phase, which includes increasing the packet transmission rate at a slower fixed rate for some time period.

Even though the TCP transmissions sequence 200 depicts typical TCP phases, other TCP algorithms may include other phases affecting flow and congestion control. As mentioned above, TCP algorithms can have more phases (or less phases) than the four shown in the TCP transmission sequence 200. That said, TCP algorithms having different characteristics (e.g., parameters, phases, etc.) may attempt to address a common problem of fundamental flow and congestion control in the network.

Considerations when designing a TCP algorithm may include the initial TCP transmission rate, history of similar traffic coming from nearby locations (e.g., as might be stored in a history table), the rate at which the initial transmission rate is increased, which slow start algorithm to implement (if any), information specified in a profile table, which events or criteria constitute a congestion event, to what extent decreasing the TCP transmission rate will mitigate congestion, the rate at which to increase the TCP transmission rate following a congestion condition, what parameters to change (if any upon approaching the past congestion event transmission rate (or whether this rate should be reached at all), etc. One or more of these considerations may depend on the choice of TCP algorithm and the setting of TCP parameters.

In some embodiments, at least some of the responsibility for managing TCP connections may be delegated to a middlebox. A middlebox may be a source endpoint, and may be configured to dynamically adjust TCP connection parameters and/or history/profile table entries in accordance with in-band signaling received from the destination endpoint. A middlebox may also be a destination endpoint, and may be configured to request or otherwise trigger adjustments to TCP connection parameters and/or history/profile table entries by communicating in-band signaling to the source endpoint.

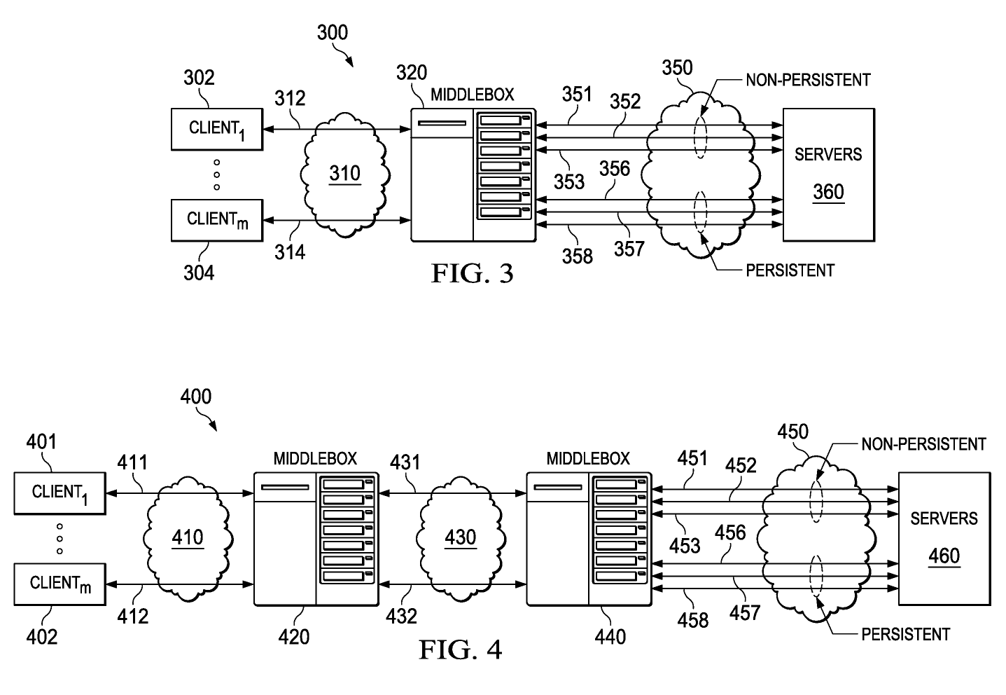

In some embodiments, a single middlebox may be implemented on the server side of the network. FIG. 3 illustrates an embodiment TCP network architecture 300 over which a middlebox 320 manages TCP connections for carrying data between a plurality of clients 302-304 and one or more servers 360. As shown, the clients 302-304 communicate with the middlebox 320 via TCP connections 312-314 spanning a first network 310, while the middlebox 320 communicates with the server 360 via TCP connections 351-358 spanning a second network 350. In some embodiments, the first network 310 has different characteristics than the second network 350. For instance, the first network 310 may be a high latency network, such as a wide area network (WAN), while the second network 350 may be a low latency network, such as a local area network (LAN). Additionally or alternatively, the first network 310 may be less reliable than the second network 350, as might be the case if the first network 310 is a wireless network and the second network 350 is a wire-line network. The TCP connections 351-358 may include a group of non-persistent TCP connections 351-353 as well as a group of persistent TCP connections 356-358.

In other embodiments, a middlebox is implemented on the client side as well as the server side. FIG. 4 illustrates an embodiment TCP network architecture 400 over which a pair of middleboxes 420-440 manage TCP connections configured to carry data between a plurality of clients 401-402 and one or more servers 460. As shown, the clients 401-402 communicate with the middlebox 420 via TCP connections 411-412 spanning a first network 410, the middlebox 420 communicates with the middlebox 440 via TCP connections 431-432 spanning a second network 430. Additionally, the TCP connections 431-432 may be persistent or non-persistent connections managed by the middleboxes 420-440. The middlebox 440 communicates with the server 460 via TCP connections 451-458 spanning a third network 450. Additionally, the TCP connections 451-458 may be persistent or non-persistent connections managed by the middleboxes 440.

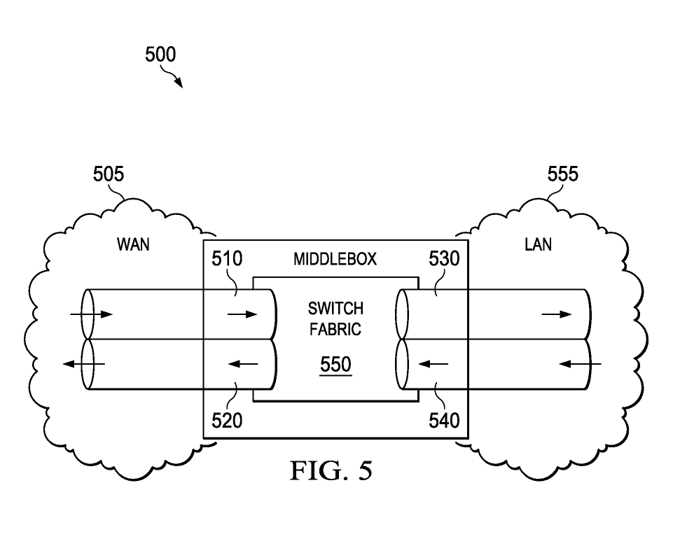

FIG. 5 illustrates an embodiment middlebox 500, as might be implemented in one of the TCP network architectures 300-400. As shown, the middlebox 500 includes an ingress WAN interface 510 and an egress WAN interface 520 for communicating data over a WAN 505, as well as an egress LAN interface 530 and an ingress LAN interface 540 for communicating data over a LAN 555. The middlebox 500 may also include a switching fabric 550 for switching data between the interfaces 510-540.

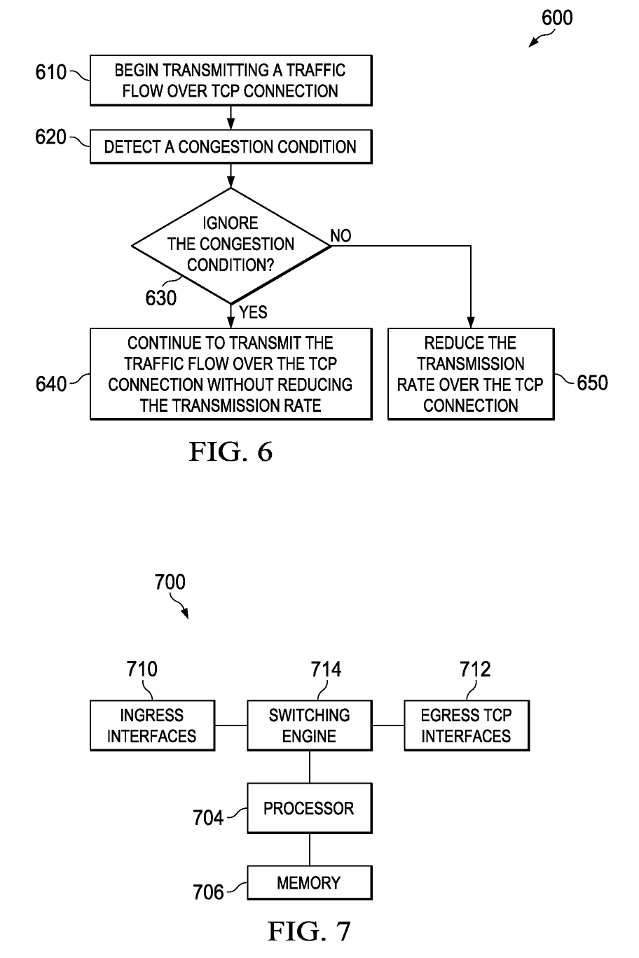

FIG. 6 illustrates a method 600 for communicating traffic flows in accordance with aspects of this disclosure, as might be performed by a source endpoint. As shown, the method 600 begins with step 610, where the source endpoint begins transmitting a traffic flow over a TPC connection. Next, the method 600 proceeds to step 620, where the source endpoint detects a congestion condition. In some embodiments, the source endpoint may detect the congestion condition upon receiving one or more duplicate ACKs from the destination endpoint indicating that a packet was not successfully received. Thereafter, the method 600 proceeds to step 630, where the source endpoint determines whether or not to ignore the congestion condition. If the source endpoint decides to ignore the congestion condition, then the method 600 proceeds to step 640, where the source endpoint continues to transmit the traffic flow over the TCP connection without reducing the transmission rate. If the source endpoint decides not to ignore the congestion condition, then the method 600 proceeds to step 650, where the source endpoint reduces the transmission rate over the TCP connection in accordance with a TCP congestion control algorithm.

When determining whether or not to ignore the congestion condition, the source endpoint may consider a variety of different factors. In one embodiment, the source endpoint chooses to ignore the congestion condition when a transmission rate over the TCP connection fails to exceed a threshold. In another embodiment, the source endpoint chooses to ignore the congestion condition when an amount of data remaining in a queue associated with the traffic flow fails to exceed a threshold, as may be indicative of a short flow or of a flow whose transmission is almost complete. In another embodiment, the source endpoint chooses to recognize or ignore the congestion condition in accordance with a characteristic of the traffic flow (e.g., priority, etc.) or a characteristic associated with a source/destination address of the traffic flow. In one embodiment, the characteristic of the traffic flow and/or source/destination address is determined by analyzing control information and/or data carried by the traffic flow.

In another embodiment, the characteristic of the traffic flow and/or source/destination address is determined in accordance with information stored in a history or profile table. A history table may be used to associate one or more characteristics with a destination or source address. By way of example, a history table may associate a particular source address with a wireless network environment. A profile table may be used to assign/re-assign a TCP congestion control algorithm to a new/persistent connection. Information stored in the history and/or profile table may be considered separately or in conjunction when determining whether or not to ignore the congestion condition. In embodiments, the history or profile table may specify a subscription level of a user associated with the traffic flow, a frequency of congestion associated with a source/destination address of the traffic flow (e.g., whether a source/destination address is classified as a chronic offender), an average round trip time (RTT) of the traffic flow, a network environment associated with a source/destination address of the traffic flow (e.g., wireless or otherwise), or any other characteristic directly or indirectly associated with the traffic flow or the source/destination address of the traffic flow. In yet other embodiments, the source endpoint may maintain the transmission rate until a certain number of duplicate ACKs are received (e.g., three ACKs, etc.) in order to ensure the presence of congestion before reducing QoS.

FIG. 7 illustrates a block diagram of an embodiment of a communications device 700, which may be equivalent to one or more devices (e.g., middlebox, etc.) discussed above. The communications device 700 may include a processor 704, a memory 706, ingress TCP interfaces 710, egress TCP interfaces 712, and a switching engine 714, which may (or may not) be arranged as shown in FIG. 7. The processor 704 may be any component capable of performing computations and/or other processing related tasks, and the memory 706 may be any component capable of storing programming and/or instructions for the processor 704. The ingress TCP interfaces 710 may be any component or collection of components that allows the communications device 700 to receive TCP packets, while the egress TCP interfaces 712 may be any component or collection of components that allows the communications device 700 to transmit TCP packets. The switching engine 714 may be any component or collection of components that allows the communications device 700 to switch TCP packets between the ingress TCP interfaces 710 and the egress TCP interfaces 712.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method for transport connection control (TCP) communication, the method comprising:
begin transmitting a traffic flow over a TCP connection;
detecting a congestion condition;
determining whether to recognize or ignore the congestion condition; and
continuing to transmit the traffic flow over the TCP connection without reducing a transmission rate over the TCP connection upon determining to ignore the congestion condition.

2. The method of claim 1, further comprising:
reducing the transmission rate over the TCP connection in accordance with a TCP congestion algorithm upon determining to recognize the congestion condition.

3. The method of claim 1, wherein determining whether to recognize or ignore the congestion condition comprises:
choosing to ignore the congestion condition when a transmission rate over the TCP connection is less than a threshold.

4. The method of claim 1, wherein determining whether to recognize or ignore the congestion condition comprises:
choosing to ignore the congestion condition when an amount of data remaining in a queue associated with the traffic flow is less than a threshold.

5. The method of claim 1, wherein determining whether to recognize or ignore the congestion condition comprises:
determining whether to recognize or ignore the congestion condition in accordance with a characteristic of the traffic flow.

6. The method of claim 1, wherein determining whether to recognize or ignore the congestion condition comprises:
choosing to ignore the congestion condition when a priority associated with the traffic flow exceeds a threshold.

7. The method of claim 1, wherein determining whether to recognize or ignore the congestion condition comprises:
determining whether to ignore the congestion condition in accordance with an entry in a history or profile table.

8. The method of claim 7, wherein determining whether to recognize or ignore the congestion condition in accordance with the entry in the history or profile table comprises:
identifying, in the history or profile table, a subscription level of a user associated with the traffic flow; and
choosing to ignore the congestion condition when the subscription level exceeds a threshold.

9. The method of claim 7, wherein determining whether to ignore the congestion condition in accordance with an entry in a history or profile table comprises:
identifying, in the history or profile table, an average traffic flow size associated with a source or destination address of the traffic flow; and
choosing to ignore the congestion condition when the average traffic flow size is less than a threshold.

10. The method of claim 7, wherein determining whether to ignore the congestion condition in accordance with an entry in a history or profile table comprises:
identifying, in the history or profile table, an average round trip time (RTT) associated with a source or destination address of the traffic flow; and
choosing to ignore the congestion condition when the average RTT is less than a threshold.

11. The method of claim 7, wherein determining whether to ignore the congestion condition in accordance with an entry in a history or profile table comprises:
determining whether to ignore the congestion condition in accordance with a characteristic associated with a destination network as specified in the history or profile table.

12. The method of claim 11, wherein determining whether to ignore the congestion condition in accordance with a characteristic associated with a destination network comprises:
choosing to ignore the congestion condition when a destination address of the traffic flow is associated with a wireless network environment.

13. The method of claim 7, wherein determining whether to ignore the congestion condition in accordance with an entry in a history or profile table comprises:
identifying, in the history or profile table, a frequency of congestion associated with a source or destination address of the traffic flow; and
choosing to ignore the congestion condition when the frequency of congestion associated with the source or destination address is less than a threshold.

14. A device configured for transport connection control (TCP) communications, the device comprising:
a processor; and
a computer readable storage medium storing programming for execution by the processor, the programming including instructions to:
begin to transmit a traffic flow over a TCP connection;
detect a congestion condition;
determine whether to recognize or ignore the congestion condition; and
continue to transmit the traffic flow over the TCP connection without reducing a transmission rate over the TCP connection upon determining to ignore the congestion condition.

15. The device of claim 14, wherein the programming further includes instructions to:
reduce the transmission rate over the TCP connection in accordance with a TCP congestion algorithm upon determining to recognize the congestion condition.

16. A method for transport connection control (TCP) communication, the method comprising:
begin transmitting a traffic flow over a TCP connection in accordance with a TCP congestion algorithm;
detecting a congestion condition;
determining whether a transmission rate over the TCP connection exceeds a threshold; and
ignoring the congestion condition when the transmission rate fails to exceed the threshold.

17. The method of claim 16 further comprising:
reducing the transmission rate over the TCP connection in accordance with the TCP congestion algorithm when the transmission rate exceeds the threshold.

18. The method of claim 16, wherein ignoring the congestion condition when the transmission rate fails to exceed the threshold comprises:
continuing to transmit the traffic flow over the TCP connection without reducing the transmission rate over the TCP connection.

19. A device configured for transport connection control (TCP) communications, the device comprising:
a processor; and
a computer readable storage medium storing programming for execution by the processor, the programming including instructions to:
begin to transmit a traffic flow over a TCP connection in accordance with a congestion algorithm;
detect a congestion condition;
determine whether a transmission rate over the TCP connection exceeds a threshold; and
ignore the congestion condition when the transmission rate fails to exceed the threshold.

20. The device of claim 19, wherein the instructions further include to ignore the congestion condition when the transmission rate fails to exceed the threshold includes instructions to:
continue to transmit the traffic flow over the TCP connection without reducing the transmission rate over the TCP connection.

21. A method for transport connection control (TCP) communication, the method comprising:
storing a traffic flow in a queue;
begin transmitting the traffic flow over a TCP connection in accordance with a congestion algorithm;
detecting a congestion condition;
determining whether an amount of data remaining in the queue exceeds a threshold; and
ignoring the congestion condition when the amount of data remaining in the queue fails to exceed the threshold.

22. The method of claim 21 further comprising:
reducing a transmission rate over the TCP connection when the amount of data remaining in the queue exceeds the threshold.

23. The method of claim 21, wherein ignoring the congestion condition when the amount of data remaining in the queue fails to exceed the threshold comprises:
completing transmission of the traffic flow over the TCP connection without reducing a transmission rate of the TCP connection.

24. A device configured for transport connection control (TCP) communications, the device comprising:
a processor; and
a computer readable storage medium storing programming for execution by the processor, the programming including instructions to:
store a traffic flow in a queue
begin to transmit the traffic flow over a TCP connection in accordance with a congestion algorithm;
detect a congestion condition;
determine whether an amount of data remaining in the queue exceeds a threshold; and
ignore the congestion condition when the amount of data remaining in the queue

25. The device of claim 24, wherein the instruction to ignore the congestion condition when the amount of data remaining in the queue fails to exceed the threshold includes instructions to:
continue to transmit the traffic flow over the TCP connection without reducing a transmission rate over the TCP connection.

26. A method for transport connection control (TCP) communication, the method comprising:
begin transmitting a traffic flow over a TCP connection in accordance with a congestion algorithm, the traffic flow including a plurality of packets;
receiving at least one duplicate acknowledgment (ACK) message indicating that one or more packets were not successfully received by a receiving device;
determining whether a number of duplicate ACK messages received exceeds a threshold; and
re-transmitting the one or more packets without reducing a transmission rate of the TCP connection when the number of duplicate ACK messages fails to exceed the threshold.

27. A device configured for transport connection control (TCP) communications, the device comprising:
a processor; and
a computer readable storage medium storing programming for execution by the processor, the programming including instructions to:
begin to transmit a traffic flow over a TCP connection in accordance with a congestion algorithm, the traffic flow including a plurality of packets
receive at least one duplicate acknowledgment (ACK) message indicating that one or more packets were not successfully received by a receiving device;
determine whether a number of duplicate ACK messages received exceeds a threshold; and
re-transmit the one or more packets without reducing a transmission rate of the TCP connection when the number of duplicate ACK messages fails to exceed the threshold.
